(19) United States
(12) Patent Application Publication
(10) Pub. No.: US 2013/0283203 A1
(43) Pub. Date: Oct. 24, 2013

(54) METHOD AND SYSTEM FOR DISPLAYING SEARCH RESULTS

(71) Applicants: Ethan Batraski, Foster City, CA (US); Olivia Franklin, San Francisco, CA (US); Jerry Cheng, Mountain View, CA (US); Scott Fish, San Carlos, CA (US)

(72) Inventors: Ethan Batraski, Foster City, CA (US); Olivia Franklin, San Francisco, CA (US); Jerry Cheng, Mountain View, CA (US); Scott Fish, San Carlos, CA (US)

(73) Assignee: YAHOO! INC., Sunnyvale, CA (US)

(21) Appl. No.: 13/454,185

(22) Filed: Apr. 24, 2012

(51) Int. Cl. G06F 3/048

(52) U.S. Cl. 715/783

(57) ABSTRACT

Method, system, and programs for displaying search results are disclosed. A first page that contains a first piece of content is presented to a user. A second page that contains a second piece of content including one or more search results is generated. The second page is arranged behind the first page such that the second page is invisible to the user. A first triggering event associated with a predetermined user input is detected. In response to the first triggering event, at least part of the first page is moved in a direction from a default position for a distance to expose at least part of the second page such that the second piece of content on the second page becomes visible to the user.

### BACKGROUND

1. Technical Field

The present teaching relates to methods, systems, and programming for user interface. Particularly, the present teaching is directed to methods, systems, and programming for displaying search results.

2. Discussion of Technical Background

Online content search is a process of interactively searching for and retrieving requested information via a search application running on a local user device, such as a computer or a mobile device (handheld or portable device), e.g., a smart phone, tablet, music player, handled gaming console, global positioning system (GPS), from online databases. Content search is conducted through search engines, which are programs running at a remote server and searching documents for specified keywords and return a list of the documents where the keywords were found.

Traditional search results are displayed on an independent destination, not part of any application on a user device but on a hosted webpage, i.e., a results page, requiring users to go to that destination in order to view the search results. From there the users can click on the results to view the resulting page, but are required to then click back to view the results page again. For example, the users have to leave the page or application they are currently on in order to access and view results. The back and forth switching operation required in traditional search solutions imposes an extra burden on the users and impairs user experience.

Therefore, there is a need to provide an improved solution for displaying search results on a user device to solve the above-mentioned problems.

### SUMMARY

The present teaching relates to methods, systems, and programming for user interface. Particularly, the present teaching is directed to methods, systems, and programming for displaying search results.

In one example, a method, implemented on at least one machine each of which has at least one processor, storage, and a communication platform connected to a network for displaying search results, is disclosed. A first page that contains a first piece of content is presented to a user. A second page that contains a second piece of content including one or more search results is generated. The second page is arranged behind the first page such that the second page is invisible to the user. A first triggering event associated with a predetermined user input is detected. In response to the first triggering event, at least part of the first page is moved in a direction from a default position for a distance to expose at least part of the second page such that the second piece of content on the second page becomes visible to the user.

In a different example, a system for displaying search results is disclosed. The system comprises a first controller and a second controller. The first controller is configured to present a first page that contains a first piece of content to a user and detect a first triggering event associated with a predetermined user input. The second controller is configured to generate a second page that contains a second piece of content including one or more search results. The second page is arranged behind the first page such that the second page is invisible to the user. The first controller is further configured to, in response to the first triggering event, move at least part of the first page in a direction from a default position for a distance to expose at least part of the second page such that the second piece of content on the second page becomes visible to the user.

Other concepts relate to software for displaying search results. A software product, in accord with this concept, includes at least one machine-readable and non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for displaying search results, wherein the information, when read by the machine, causes the machine to perform a series of steps. A first page that contains a first piece of content is presented to a user. A second page that contains a second piece of content including one or more search results is generated. The second page is arranged behind the first page such that the second page is invisible to the user. A first triggering event associated with a predetermined user input is detected. In response to the first triggering event, at least part of the first page is moved in a direction from a default position for a distance to expose at least part of the second page such that the second piece of content on the second page becomes visible to the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates hierarchical planes and view port at a default stage and a search exposed stage;

FIGS. 2-4 illustrate an exemplary process for displaying search results, according to an embodiment of the present teaching;

FIGS. 5-7 illustrate another exemplary process for displaying search results, according to an embodiment of the present teaching;

FIGS. 8 and 9 illustrate still another exemplary process for displaying search results, according to an embodiment of the present teaching;

FIGS. 10-12 illustrate yet another exemplary process for displaying search results, according to an embodiment of the present teaching;

FIG. 13 illustrates an exemplary user interface for displaying search results on a tablet user device;

FIG. 14 is an exemplary system diagram of a system for displaying search results, according to an embodiment of the present teaching;

FIG. 15 is another exemplary system diagram of a system for displaying search results, according to an embodiment of the present teaching;

FIG. 16 depicts a hierarchical architecture for controlling the display of search results, according to an embodiment of the present teaching;

FIG. 17 is a flowchart of an exemplary process for displaying search results, according to an embodiment of the present teaching;

FIG. 18 is a flowchart of another exemplary process for displaying search results, according to an embodiment of the present teaching;

FIG. 19 is a flowchart of still another exemplary process for displaying search results, according to an embodiment of the present teaching;

FIG. 20 depicts an exemplary functional block diagram of a user device on which the system for displaying search results resides, according to an embodiment of the present teaching;

FIG. 21 depicts an exemplary embodiment of a networked environment in which search results displaying is applied, according to an embodiment of the present teaching; and

FIG. 22 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of displaying and accessing search results on a user device with an improved user experience. The method and system as disclosed herein aim at providing a solution that improves end-users' search experience and does not revolve around a search results page. The present disclosure provides a hierarchical architecture where a user can access and view search results behind a browser plane from any webpage without needing to be redirected to a search results page. The method and system as disclosed herein revolutionize the interaction and experience of how a user can access and view search results content within an application, such as a web browser, without the need to ever leave the website or application.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

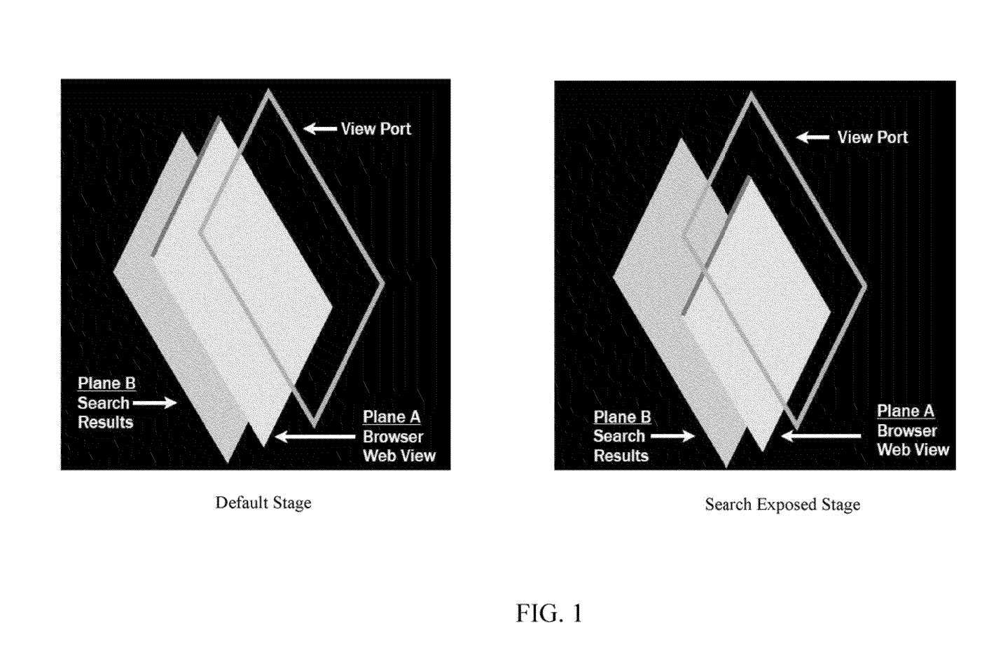

FIG. 1 illustrates hierarchical planes and view port at a default stage and a search exposed stage. In this example, the hierarchical architecture includes a first page (plane A) that resides on top of a second page (plane B). The first page may be, for example, a web browser page, e.g., INTERNET EXPLORER, FIREFOX, CHROME, SAFARI, OPERA, etc., a standalone search application page, or any application page on a user device. The first page in this example is the top plane viewed by a user at all times. In this example, the first page is a web browser page by which the user can surf the Internet via the available view port. The second page is the plane beneath, not visible to the user at the default stage. In this example, the second page is a container that displays search results. The first page is a moveable plane, which may be moved in a limited length in order to expose the second plane at the search exposed stage. The first page may be also moved back to its default position, i.e., returning back to the default stage, thus no longer exposing the second page. In other words, the hierarchical architecture in FIG. 1 establishes a relationship between the two pages whereas the first page (plane A) offers the ability to load content directly on the second page (plane B), with simple and easy access back to the first page (plane A). A set of search results may be confined in a container within an application behind the web browser page's view port. The search results in the container become visible by e.g., swiping down or up the top plane instead of requiring a user to go to a search results page. The container of the results is accessible from any webpage at any time by moving the top plane.

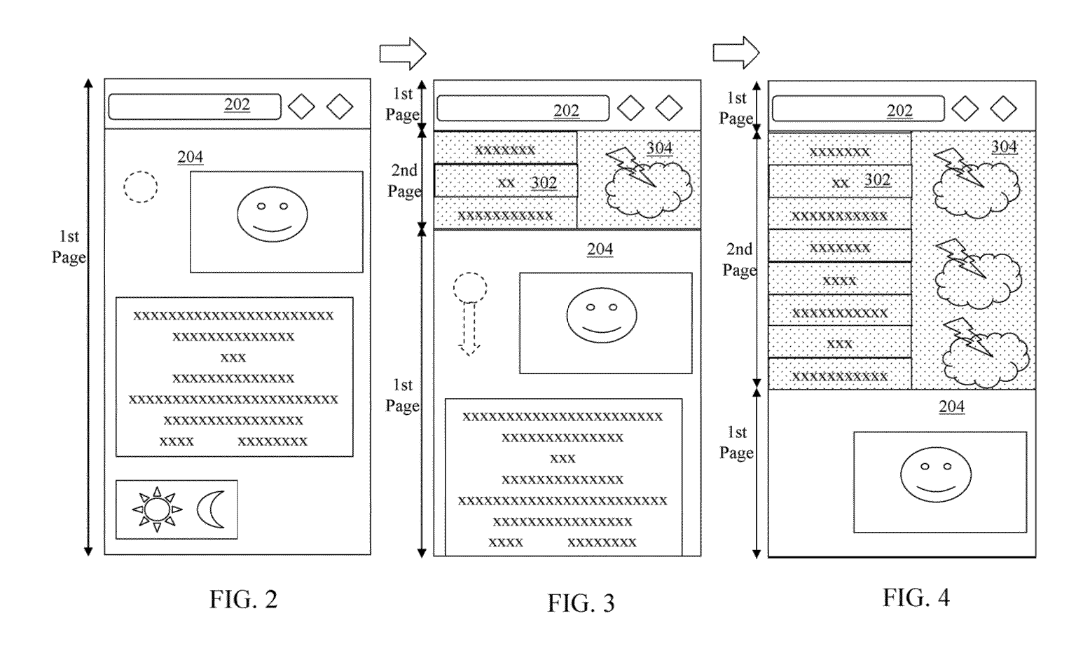

FIGS. 2-4 illustrate an exemplary process for displaying search results, according to an embodiment of the present teaching. In this example, part of the first page, e.g., a web browser page, moves down to expose the second page, e.g., a search results page, in response to a triggering event, e.g., a pulling action. In FIG. 2, the first page includes a non-movable region 202 on top of the first page, which may include a search box, an address bar, and browser controls, e.g., back, forward, home, share, etc. The first page also includes a movable region 204 corresponding to the view port of the first page where the content of the first page is presented. It is understood that in other examples, the relative position between the non-movable region 202 and the moveable region 204 may be different. For example, the non-movable region 202 may be at the bottom of the first page or on the left/right side of the first page. In any event, a pulling action is applied to the movable region 204 of the first page as a triggering event. Depending on the user device where the application resides, the pulling action may be applied by finger gestures, e.g., the user swiping on a touch screen using a finger, or by pointing device gestures, e.g., the user holding a mouse button while moving the cursor. It is understood that any predetermined user input that intuitively mimics an action of pulling the first page may be applied as the pulling action.

In any event, the pulling action starts the movement of the first page in a direction for a distance to start exposing the second page behind the first page. In this example, the second page may be a search results page including a search suggestion region 302 in the left panel and a search direct answer region 304 in the right panel. The search suggestion region 302 may display one or more query suggestions that the user may be looking for, and the search direct answer region 304 may display content related to the top query suggestion as a direct answer to the user. It is understood that in other examples, the search results page may have a different configuration and layout to show search related content, such as a list of hyperlinks as the query results. In this example, before the user starts to enter any query string in the search box in the non-movable region 202 of the first page, the search results page may have already been generated by analyzing the content and/or user search history in the web browser page to automatically create a search query and by fetching search results based on the created search query. For example, natural language processing may be applied to extract keywords indicating the topic of the content on the web browser page, and the keyword having the highest relevance score may be automatically determined as the search query. In another example, data mining may be performed on the query logs collected from all the users visiting the same content shown on the current web browser page to determine the most popular search query associated with the current content on the web browser page. In any event, once the user loads the first page, the generation of the second page starts, even before any triggering event being received. Once the triggering event is received, the second page is ready to be displayed.

In FIG. 4, the movement of the first page stops at a position determined based on the pulling action. In one example, the movement of the first page immediately stops once the pulling action stops. In another example, the direction and distance of the movement of the first page are determined by the direction and distance of the pulling action, e.g., based on a proportional relationship. In FIG. 4, all the content of the search results page may be fully exposed via the previous view port of the web browser page. In this example, a least a portion of the movable region 204 of the first page remains on the display.

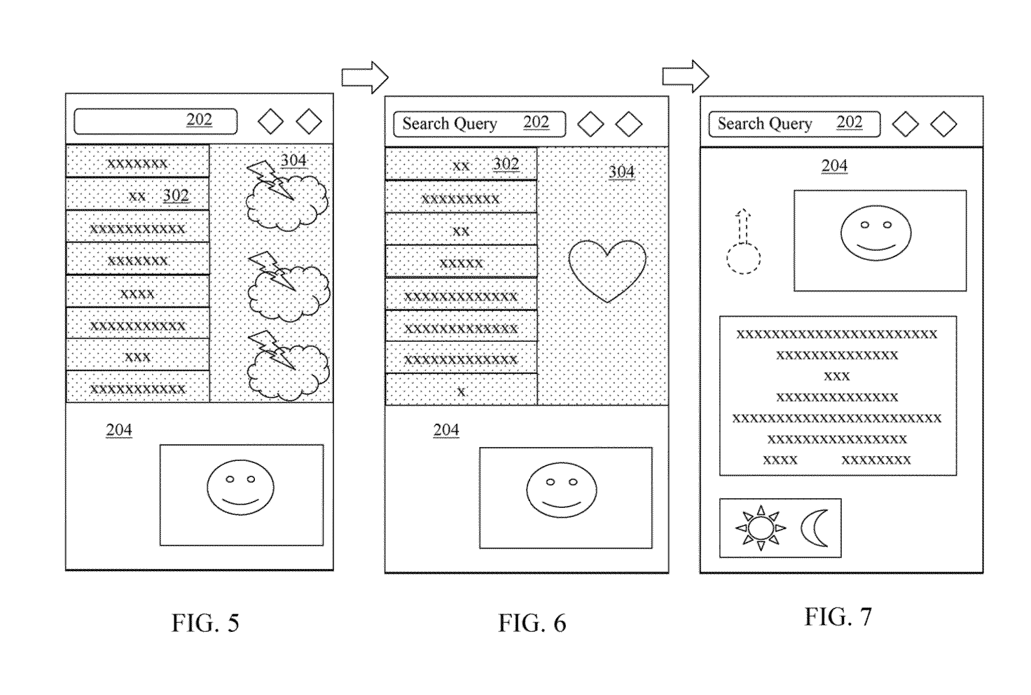

FIGS. 5-7 illustrate another exemplary process for displaying search results, according to an embodiment of the present teaching. In FIG. 5, the movable region 204 of the first page has been pulled down to expose the search suggestion region 302 and search direct answer region 304 of the second page. In this example, the user may not be satisfied with the query suggestions shown in the search suggestion region 302 and the content on the search direct answer region 304 and decide to enter a different query. In FIG. 6, once the user starts to type a new query in the search box in the non-movable region 202 of the first page, the content of the second page updates accordingly. For example, a list of query suggestions may be provided in the search suggestion region 302 based on prefix matching of the entered query string with all the query strings stored in a search suggestion database. The content of the direct answer changes as well in the search direct answer region 304. It is understood that in other examples, the user may click any query suggestion or any hyperlink of query results to continue the search, and the content refreshes accordingly on the second page. That is, the content on the second page is viewable and fully accessible via the view port of the movable region 204 of the first page at the search exposed stage.

In FIG. 7, part of the first page, i.e., the movable region 204, moves back to its default position at the default stage in response to another triggering event, e.g., a second pulling action. For example, the movable region 204 of the first page may be pulled back up or unhooked by pulling up or by pulling down a bit more to close back up into its default position, thus no longer exposing the second page. It is understood that any other intuitive user input may be predetermined as the triggering event to return the first page to its default position. For example, a pulling action followed by a releasing action applied to a touch screen of a user device may be defined as the triggering event.

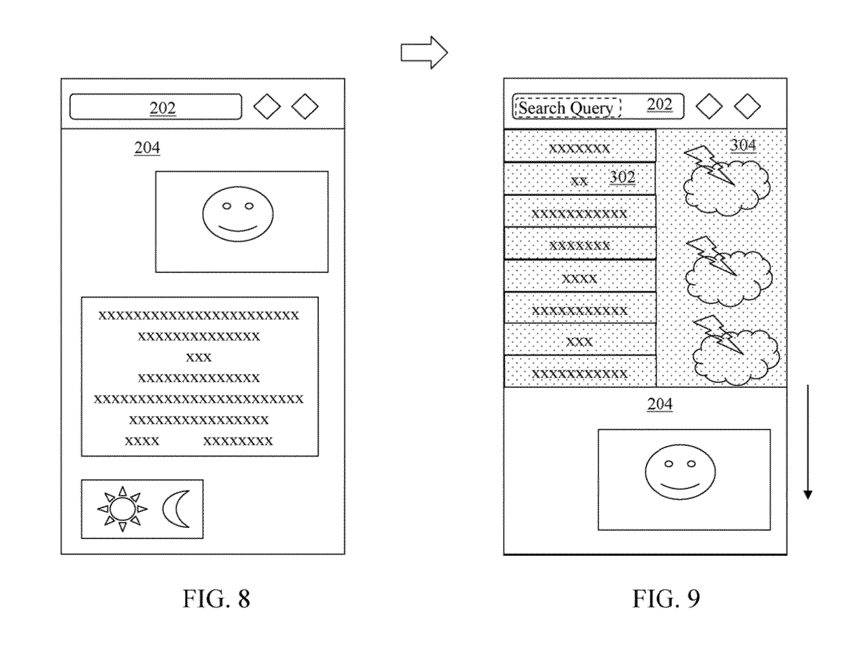

FIGS. 8 and 9 illustrate still another exemplary process for displaying search results, according to an embodiment of the present teaching. In this example, part of the first page, e.g., a web browser page, moves down to expose the second page, e.g., a search results page, in response to a user entering a search query. Different from the example shown in FIGS. 2-4, once the user starts to type in the search box in the non-movable region 202 of the first page, the movable region 204 of the first page automatically moves to expose the content of the second page. That is, the triggering event in this example is no longer an explicit action applied to the movable region 204 of the first page, but instead is an indication implying the user's intent to access and view of the search results page, e.g., entering a search query. As the triggering event in this example cannot be used to indicate the direct and distance of the movement of the movable region of the first page, the movement direct and distance may be predefined or dynamically determined based on the volume of content on the second page.

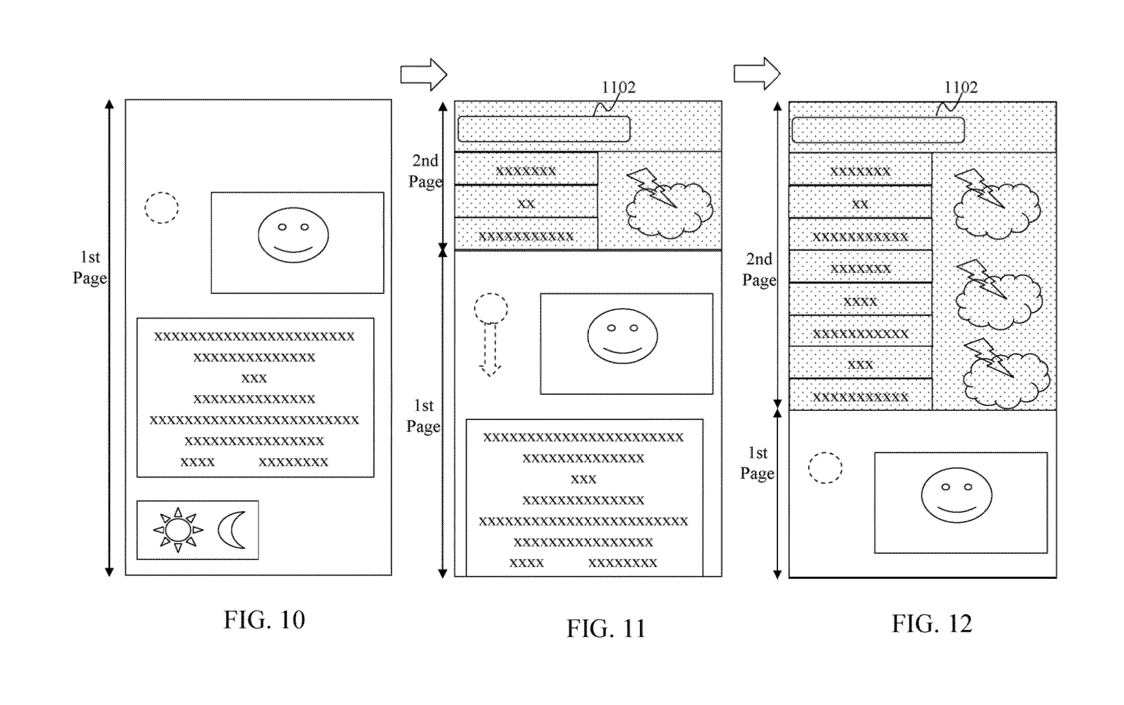

FIGS. 10-12 illustrate yet another exemplary process for displaying search results, according to an embodiment of the present teaching. Different from the example shown in FIGS. 2-4, in this example, the entire first page is movable and the non-movable region 202 in FIGS. 2-4 is now part of the second page. That is, the user may move the web browser page to expose the search box 1102 on the search results page in order to enter a search query. Once the web browser page returns to its default position, the search box 1102 is covered and becomes invisible again.

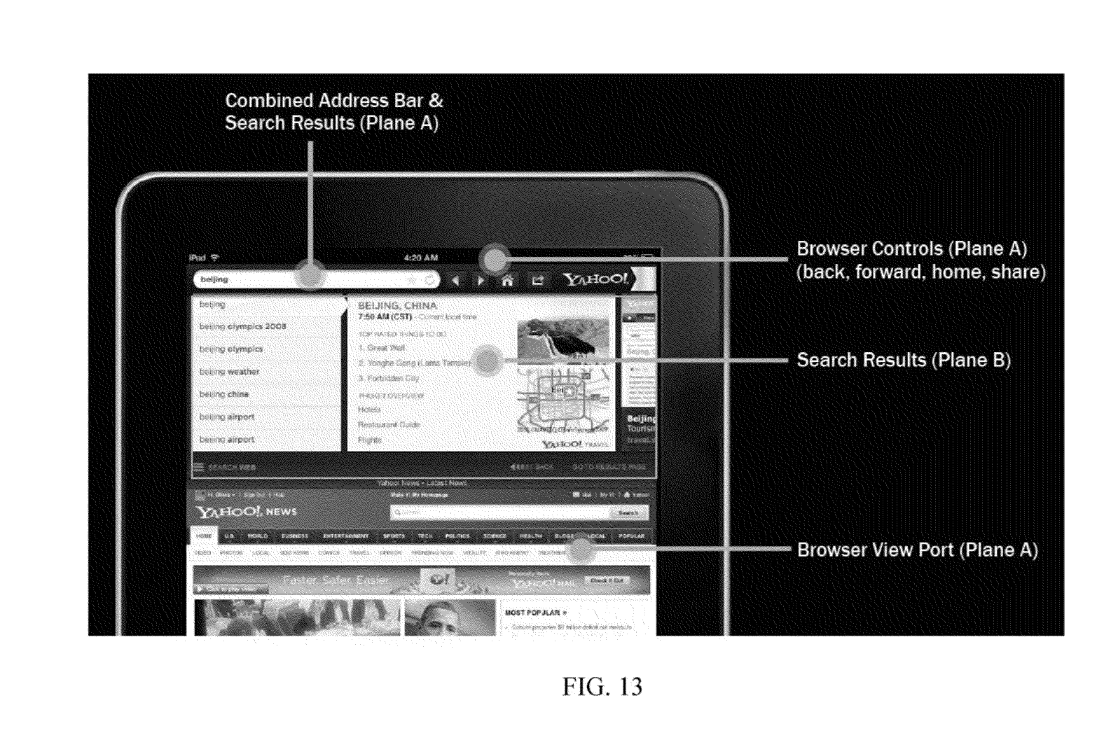

FIG. 13 illustrates an exemplary user interface for displaying search results on a tablet user device. In this example, at the search exposed stage, both the search results page (plane B) and the web browser page (plane A) are displayed on the screen of a tablet device. The user may enter a search query “beijing” in the combined address bar and search box in the non-movable region on plane A. The non-movable region also includes browser controls such as back, forward, home, and share. Query suggestions such as “beijing,” “beijing olymics 2008,” etc., and direct answers, such as time, points of interest, hotels, restaurant, Beijing, China are displayed as search results on Plane B. The movable region of plane A is the Yahoo! News web page, which may be moved up and down to expose and cover the search results on plane B so that the user no longer has to leave the Yahoo! News web page in order to search local information of Beijing.

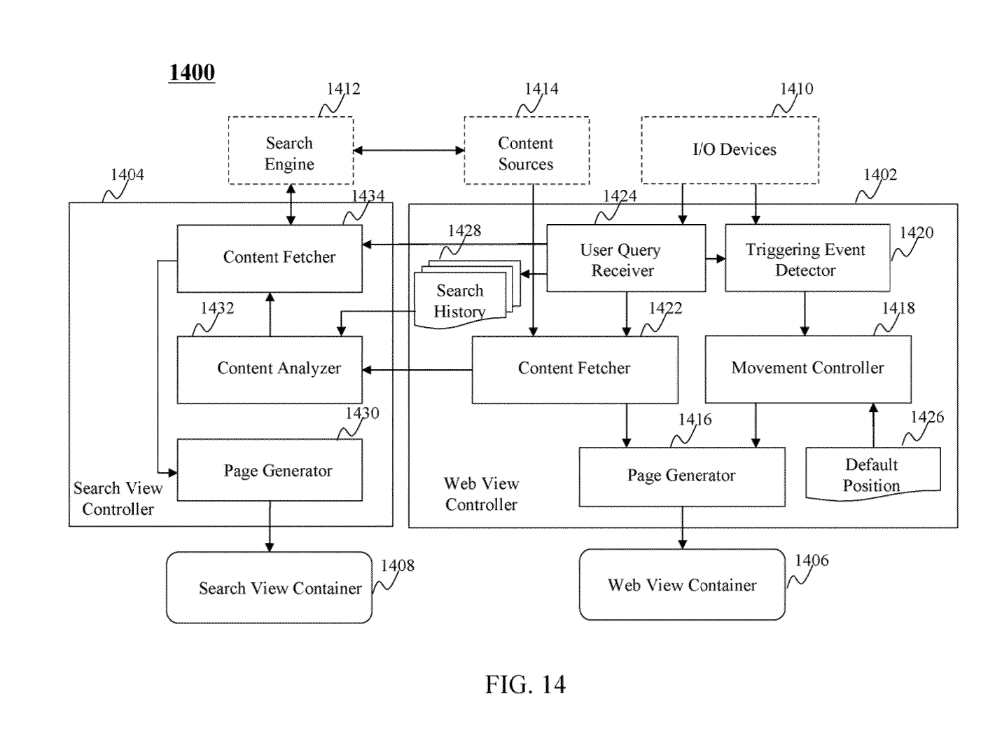

FIG. 14 is an exemplary system diagram of a system for displaying search results, according to an embodiment of the present teaching. The system 1400 includes a web view controller (a first controller) 1402, a search view controller (a second controller) 1404, a web view container 1406, and a search view container 1408. The system 1400 may be operatively coupled to input/output (I/O) devices 1410 of the local user device and remote search engines 1412 and content sources 1414.

In this example, the web view controller 1402 includes a page generator 1416, a movement controller 1418, a triggering event detector 1420, a content fetcher 1422, and a user query receiver 1424. The page generator 1416 is configured to generate a web browser page (a first page) that contains a first piece of content. The content may be fetched by the content fetcher 1422 from the content sources 1414 in accordance with an address, e.g., a uniform resource locator (URL). The content may be also fetched from a local storage, e.g., an offline cache. The address may be entered by the user through the I/O devices 1410. For example, the address may be entered through an address bar, which is part of the non-movable region of the web browser page. The content is then fed into the web view container 1406 to be presented to the user. As noted above, if the web browser page also includes a non-movable region, then the fetched content is displayed on the movable region of the web browser page.

The triggering event detector 1420 in this example is configured to detect triggering events associated with predetermined user inputs received through the I/O devices 1410. As discuss above, the user inputs include, but are not limited to, finger gestures applied to a touch screen, a touch pad, a graphical tablet, etc., pointing device gestures applied to a mouse, a track ball, a joystick, a pointing stick, a stylus, a remote controller, etc., typing, voice command, and eye tracking. In this example, at least one user input applied to part of the web browser page is predefined as a first triggering event for moving at least part of the web browser page, i.e., switching from the default stage to the search exposed stage. At discussed above, the first triggering event may include a pulling (swiping) action applied on the web browser page and entering a query string in the search box on the web browser page. The triggering event detector 1420 in this example is further configured to detect a second triggering event associated with a predetermined user input for causing the web browser page to return to its default position, i.e., switching from the search exposed stage to the default stage. The triggering event detector 1420 monitors all the user inputs to detect any predefined triggering event. If the detected predefined triggering event involves gestures such as a pulling action, the triggering event detector 1420 may further analyze the user action to determine characteristics of the user action, such as the direction and distance associated with a pulling action.

The movement controller 1418 in this example is configured to, in response to the first triggering event, move at least part of the web browser page in a direction for a distance from a default position 1426 to expose at least part of the search results page such that the second piece of content on the search results page becomes visible to the user. The default position 1426 may be recorded so that the web browser page can always return to the same position at the default stage. As discussed above, depending on the nature of the first triggering event, the direction and distance of the web browser page movement may be determined differently. In one example, the characteristics of the user action associated with the first triggering event may be applied to determine the direction and distance of the movement. For example, the direction of the movement may be substantially the same as that of the pulling action, e.g., in a vertical or horizontal direction. Swiping down the web browser page may cause the web browser page to move downward. The distance of the web browser page movement may be proportional to the distance or duration of the pulling action, e.g., substantially the same. For example, the web browser page may stop moving once the user stops the pulling action. In another example, a predetermined direction and distance may be applied for certain triggering events, such as entering a search query in the search box. In still another example, the direction and distance of the web browser page movement may be dynamically determined based on the volume of content on the search results page that needs to be exposed. For example, the more content on the search results page, the further the web browser page needs to move in order to show all the content. The movement controller 1418 in this example is configured to, in response to the second triggering event, move the at least part of the web browser page back to the default position 1426 to cover the exposed part of the search results page.

The user query receiver 1424 in this example may be responsible for receiving any user query via, for example, the search box on the web browser page. In some examples, the received query may be provided to the triggering event detector 1420 to determine whether it corresponds to a predetermined triggering event. In some examples, the search box may be on the non-movable region of the web browser page such that the query received through the search box may be provided to the search view controller 1404 in order to update the content on the search results page based on the query. All the queries may be recorded as search history 1428 to be used by the search view controller 1404 if necessary.

The search view controller 1404 in this example includes a page generator 1430, a content analyzer 1432, and a content fetcher 1434. The page generator 1430 in this example is configured to generate a search results page (a second page) that contains a second piece of content including one or more search results. The search results page is arranged behind the web browser page such that the search results page is invisible to the user at the default stage. Similar to the web browser page, the content on the search results page is fed into the search view container 1408. At the default stage, as the search view container 1408 is arranged behind the web view container 1406, e.g., having different Z-index, the search results page is covered by the web browser page. As disused above, the page generator 1430 starts to generate the search results page as soon as the web browser page is generated even when the search results page is still invisible to the user at the default stage.

The content fetcher 1434 of the search view controller 1404 is responsible for dynamically fetching search results through the search engine 1412 in conjunction with the content sources 1414 based on the received user query. The content, e.g., search results including search suggestions and direct answers, then may be dynamically refreshed by the page generator 1430 in response to receiving a new query. In this example, the content analyzer 1432 is configured to analyze the first piece of content and/or user search history information on the web browser page to automatically generate at least one search query. The content fetcher 1434 then fetches content for the search results page including one or more search results based on the automatically generated search query. That is, immediately after the user loads the web browser page without entering any search query, the content analyzer 1432 may automatically determine a query that the user is most likely interested in based on, for example, natural language processing on the content of the web browser page. For example, for a webpage reporting President Obama's Health Reform Act news, the query may be automatically determined as “health reform act” or “obama.” The specific user's search behaviors pattern, e.g., reflected by the search history 1428, or other users' search trend on the same web page obtained by data mining on user query logs may be taken into consideration in determining the query. For example, the search history 1428 may indicate that the specific user is particular interested in searching healthcare-related information. Thus, the query “health reform act” may be more relevant than the query “obama.” In any event, the automatically generated query is used to fetch search results as content on the search results page even before the user starts to type anything in the search box.

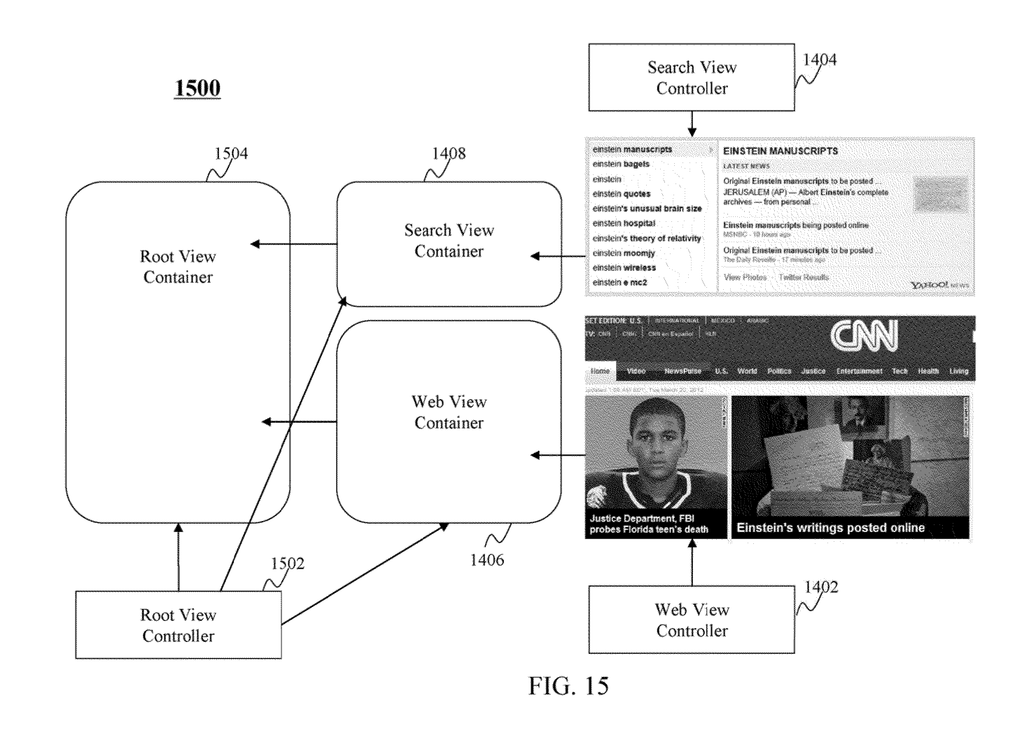

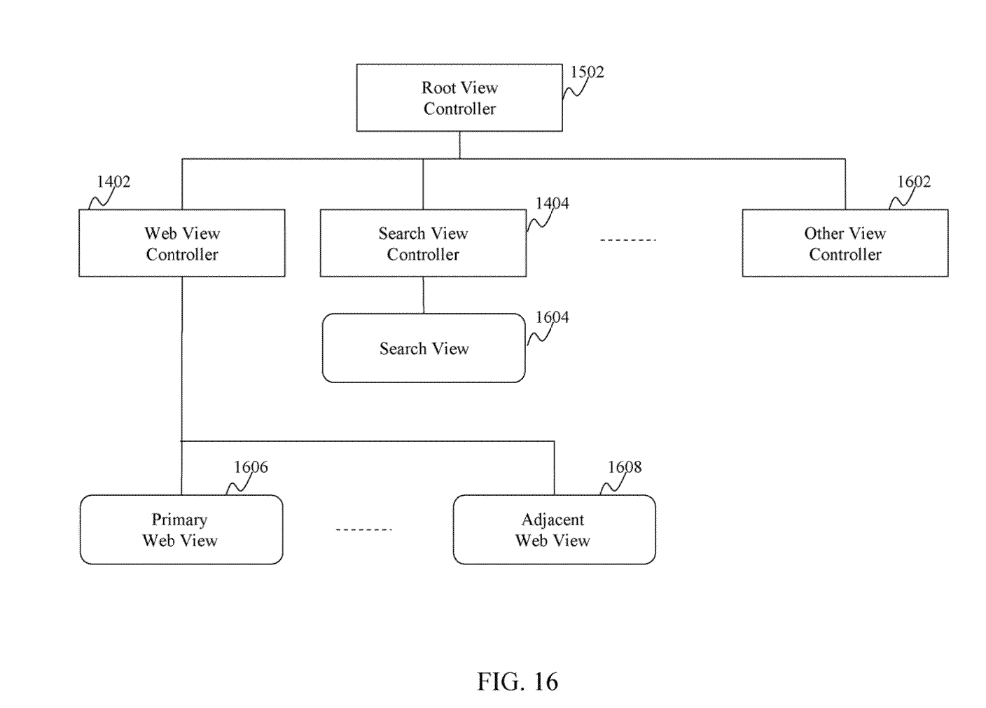

FIG. 15 is another exemplary system diagram of a system for displaying search results, according to an embodiment of the present teaching. In addition to the web view controller 1402, search view controller 1404, web view container 1406, and search view container 1408, as discussed above with respect to FIG. 14, the system 1500 includes a root view controller 1502 and a root view container 1504. The root view controller 1502 and root view container 1504 are the root node of a hierarchical architecture as further depicted in FIG. 16. The root view controller 1502 is responsible for determining the relative position between each container, e.g., the search view container 1408 and the web view container 1406, in particular, in the Z direction with respect to the display plane. In this example, the web view container 1406 is arranged to be on top of the search view container 1408 by the root view controller 1502. If there is another page to be displayed, then a corresponding view container may be provided and its Z position with respect to the search view container 1408 and web view container 1406 is determined by the root view controller 1502. The content for each page is fed into a corresponding view container. Eventually, all the view containers are organized under the root view container 1504. In this example, the search view controller 1404 feeds the search results page into the search view container 1408, and the web view controller 1402 feeds the web browser page into the web view container 1406, both of which are organized under the root view container 1504 by the root view controller 1502 based on the hierarchical architecture.

As shown in FIG. 16, under the root view controller 1502, other view controllers 1602 may be included to control the generation of other pages in corresponding containers, which have different Z index such that they overlap with each other in the Z direction. It is understood that each page may include one or more views accessible and viewable for the user through the view port. For example, the web browser page may include a primary web view 1606 and multiple adjacent web views 1608 that are outside of user's view port by default. The user can switch between different web views by moving them in and out the view port by user inputs, such as swiping the web browser page left and right or clicking a corresponding tap for each web view. In this way, more content on the web browser page may be presented to the user in a limited display area. Each web view of the web browser page is controlled by the web view controller 1402. In this example, the search results page may include only one search view 1604, while in other examples, a primary search view and adjacent search views may be created and controlled by the search view controller 1404.

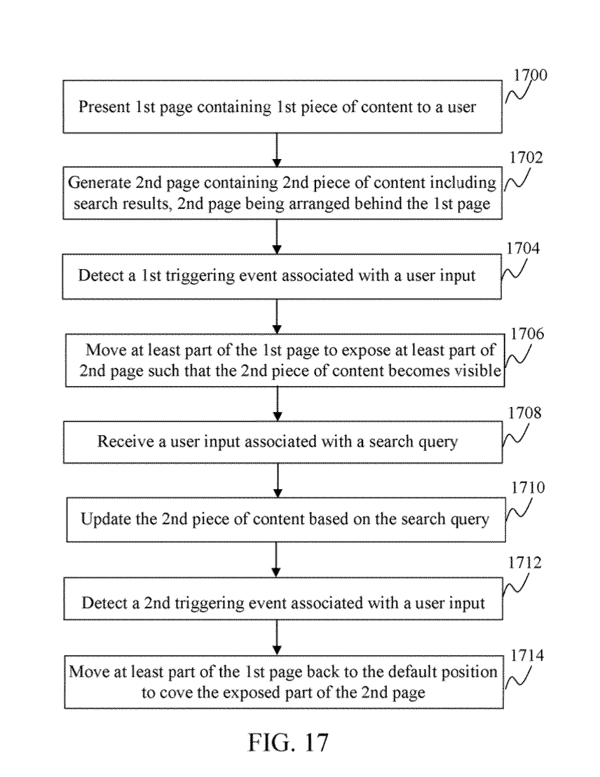

FIG. 17 is a flowchart of an exemplary process in which search results displaying is performed, according to an embodiment of the present teaching. It will be described with reference to the above figures. However, any suitable module or unit may be employed. Beginning at block 1700, a first page containing a first piece of content is presented to a user. The first page may be a web browser page. As described above, this may be performed by the web view controller 1402 in conjunction with the web view container 1406. At block 1702, processing may continue where a second page containing a second piece of content including search results is generated. The second page may be a search results page arranged behind the first page at the default stage. As described above, this may be performed by the search view controller 1404 in conjunction with the search view container 1408. At block 1704, a first triggering event associated with a user input is detected. The first triggering event may be a gesture or entering of a query. Moving to block 1706, in response to the first triggering event, at least part of the first page is moved to expose at least part of the second page such that the second piece of content becomes visible. The user now is able to access the search results page for content searching. At block 1708, a user input associated with a search query is received, for example, through a search box on the web browser page. As described above, blocks 1704, 1706, 1708 may be performed by the web view controller 1402. Proceeding to block 1710, the second piece of content, e.g., the search results on the search results page, is updated based on the received search query. As described above, this may be performed by the search view controller 1404. At block 1712, a second triggering event associated with a user input is detected. At block 1714, in response to the second triggering event, the least part of the first page is moved back to the default position to cover the exposed part of the second page. The user is now able to resume the previous browsing activity on the web browser page. As described above, blocks 1712, 1714 may be performed by the web view controller 1402.

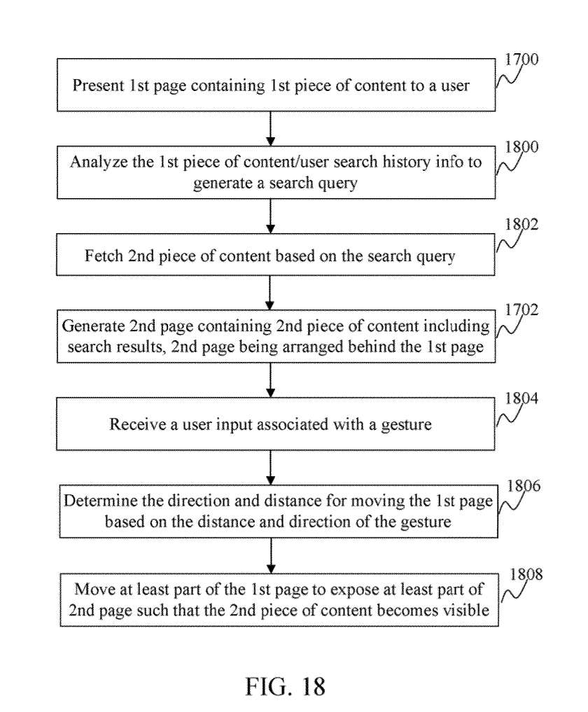

FIG. 18 is a flowchart of another exemplary process in which search results displaying is performed, according to an embodiment of the present teaching. It will be described with reference to the above figures. However, any suitable module or unit may be employed. Beginning at block 1700, a first page containing a first piece of content is presented to a user. The first page may be a web browser page. As described above, this may be performed by the web view controller 1402 in conjunction with the web view container 1406. At block 1800, the content of the first page and/or the user's search history information are analyzed to automatically generate a search query. Moving to block 1802, a second piece of content including search results is fetched based on the generated search query. At block 1702, processing may continue where the second page containing the second piece of content is generated. The second page may be a search results page arranged behind the first page at the default stage. As described above, blocks 1800, 1802, 1702 may be performed by the search view controller 1404 in conjunction with the search view container 1408. At block 1804, a user input associated with a gesture, such as a finger gesture or a pointing device gesture, is received. At block 1806, the direction and distance for moving the first page is determined based on the distance and direction associated with the gesture. Moving to block 1808, based on the determined direction and distance, at least part of the first page is then moved to expose at least part of the second page such that the second piece of content becomes visible. The user now is able to access the search results page for content searching. As described above, blocks 1804, 1806, 1808 may be performed by the web view controller 1402.

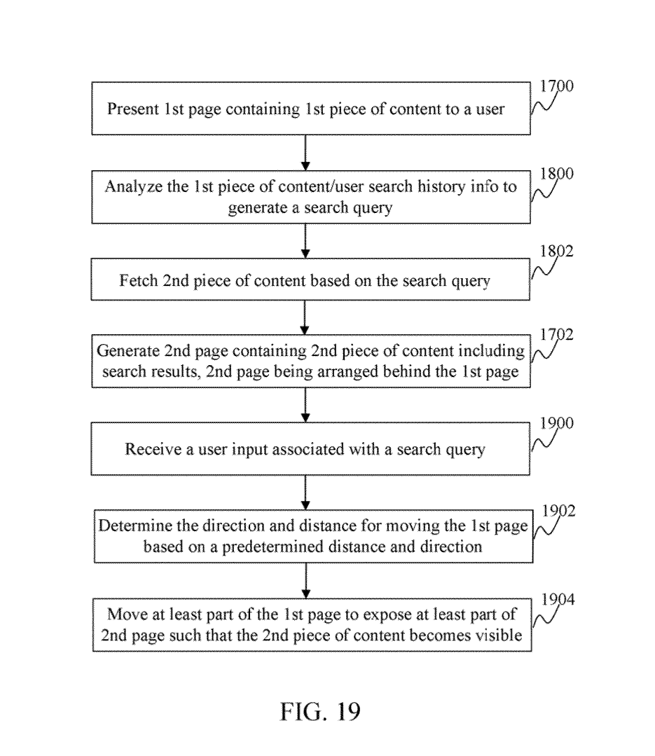

FIG. 19 is a flowchart of still another exemplary process in which search results displaying is performed, according to an embodiment of the present teaching. It will be described with reference to the above figures. However, any suitable module or unit may be employed. Beginning at block 1700, a first page containing a first piece of content is presented to a user. The first page may be a web browser page. As described above, this may be performed by the web view controller 1402 in conjunction with the web view container 1406. At block 1800, the content of the first page and/or the user's search history information are analyzed to automatically generate a search query. Moving to block 1802, a second piece of content including search results is fetched based on the generated search query. At block 1702, processing may continue where the second page containing the second piece of content is generated. The second page may be a search results page arranged behind the first page at the default stage. As described above, blocks 1800, 1802, 1702 may be performed by the search view controller 1404 in conjunction with the search view container 1408. At block 1900, a user input associated with a search query is received, for example, through the search box on the web browser page. At block 1902, the direction and distance for moving the first page is determined based on a predetermined distance and direction. Moving to block 1904, based on the predetermined direction and distance, at least part of the first page is then moved to expose at least part of the second page such that the second piece of content becomes visible. The user now is able to access the search results page for content searching. As described above, blocks 1900, 1902, 1904 may be performed by the web view controller 1402.

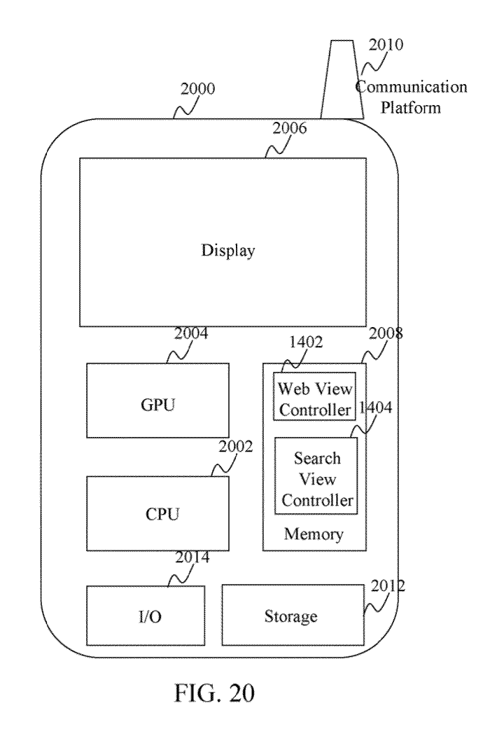

FIG. 20 depicts an exemplary functional block diagram of a user device on which the system for display search results resides, according to an embodiment of the present teaching. In this example, the user device is a mobile device 2000, including but is not limited to, a smart phone, tablet, music player, handled gaming console, GPS. The mobile device 2000 in this example includes one or more central processing units (CPUs) 2002, one or more graphic processing units (GPUs) 2004, a display 2006, a memory 2008, a communication platform 2010, such as a wireless communication module, a storage 2012, and one or more I/O devices 2014. Any other suitable component, such as but not limited to a system bus or a controller (not shown), may also be included in the mobile device 2000. As shown in FIG. 20, the web view controller 1402 and the search view controller 1404 may be loaded into the memory 2008 from the storage 2012 in order to be executed by the CPU 2002. The web view controller 1402 and the search view controller 1404 may be, for example, a software library in the form of compiled binary that is integrated in a web browser or a standalone search application on various mobile operating systems, e.g., iOS, Android, Windows Phone, etc. Execution of the web view controller 1402 and the search view controller 1404 may cause the mobile device 2000 to perform the processing as described above, e.g., in FIGS. 10-12. For example, the web browser page and search results page may be presented to the user by the GPU 2004 in conjunction with the display 2006. The search query and user inputs as triggering events may be received from the user through the I/O devices 2014. The search query and results may be communicated with remote search engines through the communication platform 2010.

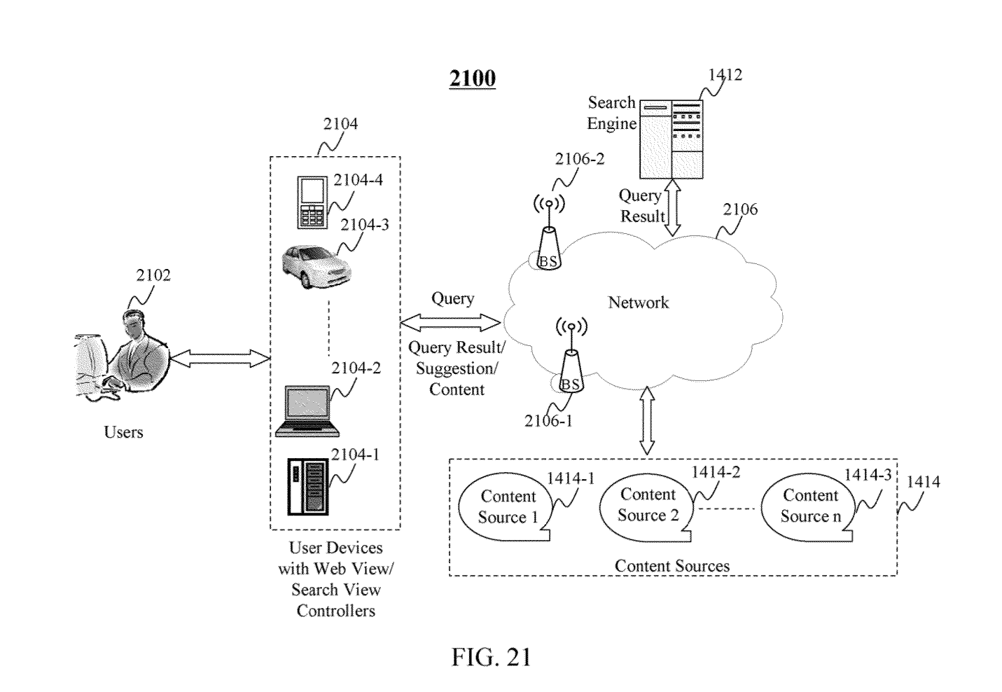

FIG. 21 depicts an exemplary embodiment of a networked environment in which search results displaying is applied, according to an embodiment of the present teaching. In FIG. 21, the exemplary networked environment 2100 includes a search engine 1412, one or more users 2102, user devices 2104 having the web view controller 1402 and the search view controller 1404, a network 2106, and content sources 1414. The network 2106 may be a single network or a combination of different networks. For example, the network 2106 may be a local area network (LAN), a wide area network (WAN), a public network, a private network, a proprietary network, a Public Telephone Switched Network (PSTN), the Internet, a wireless network, a virtual network, or any combination thereof. The network 2106 may also include various network access points, e.g., wired or wireless access points such as base stations or Internet exchange points 2106-1, . . . , 2106-2, through which a data source may connect to the network in order to transmit information via the network.

Users 2102 may be of different types such as users connected to the network 2106 via different user devices 2104 having the web view controller 1402 and the search view controller 1404, including for example, desktop computers 2104-1, laptop computers 2104-2, a built-in device in a motor vehicle 2104-3, or a mobile device 2104-4. The user devices 2104 may send a request associated with a search query to the search engine 1412 via the network 2106 based on user's 2102 inputs and receive query results from the search engine 1412. The search engine 1412 in this example may work as backend support to provide desired query results to the user devices 2104. That is, the user devices 2104 in this example may use the search engine 1412 as a vendor to process a search query in the user request.

The content sources 1414 include multiple content sources 1414-1, 1414-2, . . . , 1414-3. A content source may correspond to a web site hosted by an entity, whether an individual, a business, or an organization such as USPTO.gov, a content provider such as cnn.com and Yahoo.com, a social network website such as Facebook.com, or a content feed source such as TWITTER or blogs. The search engine 1412 and the user devices 2104 may access information from any of the content sources 1414-1, 1414-2, . . . , 1414-3. For example, the search engine 1412 may fetch content, e.g., webpages, through its web crawler to build a search index. The web view controller 1402 on the user devices 2104 may fetch content of a webpage based on the URL entered by the user 2102.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

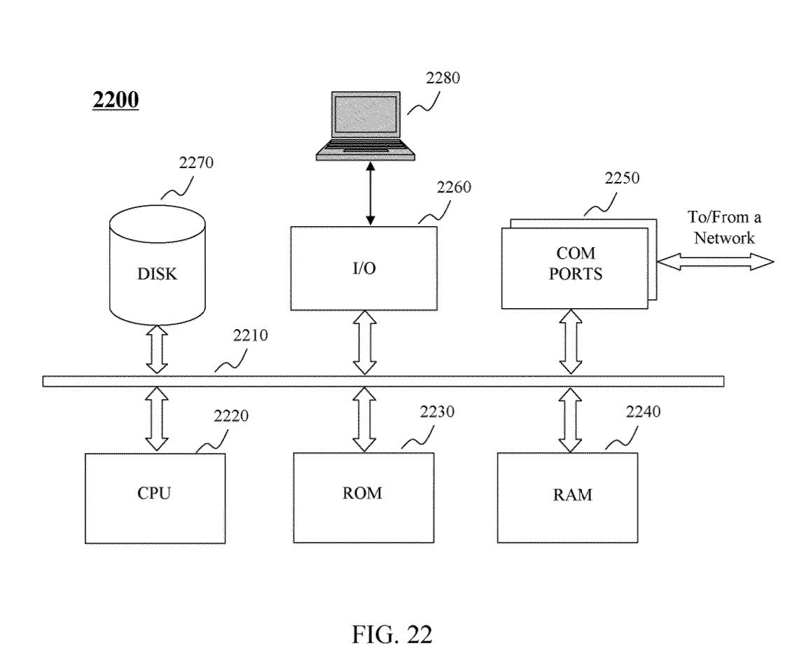

FIG. 22 depicts a general computer architecture on which the present teaching can be implemented and has a functional block diagram illustration of a computer hardware platform that includes user interface elements. The computer may be a general-purpose computer or a special purpose computer. This computer 2200 can be used to implement any components of the search results displaying architecture as described herein. Different components of the system, e.g., as depicted in FIG. 14, can all be implemented on one or more computers such as computer 2200, via its hardware, software program, firmware, or a combination thereof. Although only one such computer is shown, for convenience, the computer functions relating to search results displaying may be implemented in a distributed fashion on a number of similar platforms, to distribute the processing load.

The computer 2200, for example, includes COM ports 2202 connected to and from a network connected thereto to facilitate data communications. The computer 2200 also includes a central processing unit (CPU) 2204, in the form of one or more processors, for executing program instructions. The exemplary computer platform includes an internal communication bus 2206, program storage and data storage of different forms, e.g., disk 2208, read only memory (ROM) 2210, or random access memory (RAM) 2212, for various data files to be processed and/or communicated by the computer, as well as possibly program instructions to be executed by the CPU. The computer 2200 also includes an I/O component 2214, supporting input/output flows between the computer and other components therein such as user interface elements 2216. The computer 2200 may also receive programming and data via network communications.

Hence, aspects of the method of displaying search results, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, implemented on at least one machine each of which has at least one processor, storage, and a communication platform connected to a network for displaying search results, the method comprising the steps of:
presenting a first page that contains a first piece of content to a user;
generating a second page that contains a second piece of content including one or more search results, the second page being arranged behind the first page such that the second page is invisible to the user;
detecting a first triggering event associated with a predetermined user input; and
in response to the first triggering event, moving at least part of the first page in a direction from a default position for a distance to expose at least part of the second page such that the second piece of content on the second page becomes visible to the user.

2. The method of claim 1, further comprising:
detecting a second triggering event associated with a predetermined user input; and
in response to the second triggering event, moving the at least part of the first page back to the default position to cover the exposed part of the second page.

3. The method of claim 1, wherein the step of detecting a first triggering event comprises:
receiving a user input associated with a gesture; and
in response to the user input, determining the direction and the distance for moving the at least part of the first page based on a distance and a direction associated with the gesture.

4. The method of claim 3, wherein
the gesture includes a pulling action that pulls the at least part of the first page in a vertical or horizontal direction, the pulling action being received through a touch screen where the first page is presented; and
the direction and the distance for moving the at least part of the first page are substantially the same as those of the pulling action.

5. The method of claim 1, wherein the step of detecting a first triggering event comprises:
receiving a user input associated a search query entered through the first page; and
in response to the user input, determining the direction and the distance for moving the at least part of the first page based on a predetermined direction and a predetermined distance.

6. The method of claim 1, wherein the step of generating a second page comprises:
analyzing the first piece of content and/or user search history information in the first page to generate at least one search query; and
fetching the second piece of content including the one or more search results based on the at least one search query.

7. The method of claim 1, further comprising:
after moving the at least part of the first page, receiving a user input associated with a search query; and
updating the second piece of content on the second page based on the search query, wherein the updated second piece of content is visible to the user through the exposed part of the second page.

8. The method of claim 1, wherein the first page is a web browser page.

9. A system for displaying search results, comprising:
a first controller configured to:
present a first page that contains a first piece of content to a user, and
detect a first triggering event associated with a predetermined user input; and
a second controller configured to generate a second page that contains a second piece of content including one or more search results, the second page being arranged behind the first page such that the second page is invisible to the user, wherein
the first controller is further configured to, in response to the first triggering event, move at least part of the first page in a direction from a default position for a distance to expose at least part of the second page such that the second piece of content on the second page becomes visible to the user.

10. The system of claim 9, wherein the first controller is further configured to:
detect a second triggering event associated with a predetermined user input; and
in response to the second triggering event, move the at least part of the first page back to the default position to cover the exposed part of the second page.

11. The system of claim 9, wherein the first controller is further configured to:
receive a user input associated with a gesture; and
in response to the user input, determine the direction and the distance for moving the at least part of the first page based on a distance and a direction associated with the gesture.

12. The system of claim 11, wherein
the gesture includes a pulling action that pulls the at least part of the first page in a vertical or horizontal direction, the pulling action being received through a touch screen where the first page is presented; and
the direction and the distance for moving the at least part of the first page are substantially the same as those of the pulling action.

13. The system of claim 9, wherein the first controller is further configured to:
receive a user input associated a search query entered through the first page; and
in response to the user input, determine the direction and the distance for moving the at least part of the first page based on a predetermined direction and a predetermined distance.

14. The system of claim 9, wherein the second controller is further configured to:
analyze the first piece of content and/or user search history information in the first page to generate at least one search query; and
fetch the second piece of content including the one or more search results based on the at least one search query.

15. The system of claim 9, wherein
the first controller is further configured to receive a user input associated with a search query; and
the second controller is further configured to update the second piece of content on the second page based on the search query, the updated second piece of content being visible to the user through the exposed part of the second page.

16. A machine-readable tangible and non-transitory medium having information for displaying search results recorded thereon, wherein the information, when read by the machine, causes the machine to perform the following:
presenting a first page that contains a first piece of content to a user;
generating a second page that contains a second piece of content including one or more search results, the second page being arranged behind the first page such that the second page is invisible to the user;
detecting a first triggering event associated with a predetermined user input; and
in response to the first triggering event, moving at least part of the first page in a direction from a default position for a distance to expose at least part of the second page such that the second piece of content on the second page becomes visible to the user.

17. The medium of claim 16, further comprising:
detecting a second triggering event associated with a predetermined user input; and
in response to the second triggering event, moving the at least part of the first page back to the default position to cover the exposed part of the second page.

18. The medium of claim 16, wherein the step of detecting a first triggering event comprises:
receiving a user input associated with a gesture; and
in response to the user input, determining the direction and the distance for moving the at least part of the first page based on a distance and a direction associated with the gesture.

19. The medium of claim 18, wherein
the gesture includes a pulling action that pulls the at least part of the first page in a vertical or horizontal direction, the pulling action being received through a touch screen where the first page is presented; and
the direction and the distance for moving the at least part of the first page are substantially the same as those of the pulling action.

20. The medium of claim 16, wherein the step of detecting a first triggering event comprises:
receiving a user input associated a search query entered through the first page; and
in response to the user input, determining the direction and the distance for moving the at least part of the first page based on a predetermined direction and a predetermined distance.

21. The medium of claim 16, wherein the step of generating a second page comprises:
analyzing the first piece of content and/or user search history information in the first page to generate at least one search query; and
fetching the second piece of content including the one or more search results based on the at least one search query.

22. The medium of claim 16, further comprising:
after moving the at least part of the first page, receiving a user input associated with a search query; and
updating the second piece of content on the second page based on the search query, wherein the updated second piece of content is visible to the user through the exposed part of the second page.
